(19) United States
(12) Patent Application Publication
(10) Pub. No.: US 2025/0109628 A1
(43) Pub. Date: Apr. 3, 2025

(54) DOOR SWING GAP SEALER

(71) Applicant: Hide-A-Way Doors, LLC, Morristown, TN (US)

(72) Inventor: Christopher Patrick Rupell, SR., Morristown, TN (US)

(21) Appl. No.: 18/824,199

(22) Filed: Sep. 4, 2024

Related U.S. Application Data
(60) Provisional application No. 63/587,181, filed on Oct. 2, 2023.

(51) Int. Cl. E06B 7/18; E06B 5/00

(52) U.S. Cl. CPC E06B 7/18; E06B 5/00

(57) ABSTRACT

Various implementations include a swing gap cover device. The device includes a base, a seal bar, and one or more springs. The seal bar is configured to contact a top edge of a door hingedly coupled to the door jamb. The one or more springs are coupled to the base and the seal bar. The one or more springs are configured to bias the seal bar toward an extended position and urgable toward a retracted position. The seal bar is further from the base in the extended position than it is in the retracted position.

### BACKGROUND

Hidden doors are used to conceal the entryways into hidden rooms. Many hidden doors are designed to appear to be a portion of a wall, a bookshelf, a piece of furniture, or anything other than a door.

To effectively conceal an entryway, the gap between the hidden door and the edges of the entryway should be as unnoticeable as possible. However, hinging doors must have some space between it and the edges of the entryway to allow for movement. Thus, a gap of some size is necessary.

While a gap between the door and the entryway can be made small, light on the opposite side of the door can often be seen through the gap, exposing the hidden door.

### SUMMARY

Various implementations include a swing gap cover device. The device includes a base, a seal bar, and one or more springs. The seal bar is configured to contact a top edge of a door hingedly coupled to the door jamb. The one or more springs are coupled to the base and the seal bar. The one or more springs are configured to bias the seal bar toward an extended position and urgable toward a retracted position. The seal bar is further from the base in the extended position than it is in the retracted position.

In some implementations, the device further includes one or more tensioning devices configured to limit a maximum distance between the base and the seal bar. In some implementations, the one or more tensioning devices include one or more threaded fasteners. In some implementations, rotation of the one or more threaded fasteners changes the maximum distance. In some implementations, the base defines one or more threaded openings. In some implementations, the seal bar defines one or more through openings. In some implementations, each of the one or more threaded fasteners is disposed within a different one of the one or more through openings and is threadingly engaged with a different one of the one or more threaded openings. In some implementations, each of the one or more through openings defines a countersunk portion. In some implementations, the one or more threaded fasteners includes a head disposed within the countersunk portion of the different one of the one or more through openings in which the threaded fastener is disposed.

In some implementations, the one or more springs includes two or more springs. In some implementations, the one or more springs includes one or more compression springs.

In some implementations, the seal bar includes wood.

In some implementations, the base is configured to be disposed within an opening in a head jamb of a door jamb. In some implementations, the base is a portion of a head jamb of a door jamb.

Various other implementations include a swing gap cover system. The system includes a door, a door jamb including a head jamb, and a device coupled to the head jamb. The device includes a seal bar and one or more springs coupled to the seal bar. The one or more springs are configured to bias the seal bar toward an extended position and urgable toward a retracted position. The seal bar is further from the head jamb in the extended position than it is in the retracted position. The seal bar is configured to contact a top edge of the door in the extended position.

In some implementations, the device further includes one or more tensioning devices configured to limit a maximum distance between the head jamb and the seal bar. In some implementations, the one or more tensioning devices include one or more threaded fasteners. In some implementations, rotation of the one or more threaded fasteners changes the maximum distance.

In some implementations, the device further includes a base. In some implementations, the one or more springs are coupled to the base and the seal bar. In some implementations, the seal bar is further from the base in the extended position than it is in the retracted position. In some implementations, the base defines one or more threaded openings. In some implementations, the seal bar defines one or more through openings. In some implementations, each of the one or more threaded fasteners are disposed within a different one of the one or more through openings and is threadingly engaged with a different one of the one or more threaded openings. In some implementations, each of the one or more through openings defines a countersunk portion. In some implementations, the one or more threaded fasteners includes a head deposed within the countersunk portion of the different one of the one or more through openings in which the threaded fastener is disposed.

In some implementations, the one or more springs include two or more springs. In some implementations, the one or more springs include one or more compression springs.

In some implementations, the seal bar includes wood.

In some implementations, the device further includes a base. In some implementations, the one or more springs are coupled to the base and the seal bar. In some implementations, the seal bar is further from the base in the extended position than it is in the retracted position. In some implementations, the base is configured to be disposed within an opening in the head jamb of the door jamb. In some implementations, the base is a portion of the head jamb of the door jamb.

In some implementations, the door includes a hidden door.

In some implementations, a portion of the door remains in contact with the seal bar throughout the entire swing of the door.

### BRIEF DESCRIPTION OF DRAWINGS

Example features and implementations of the present disclosure are disclosed in the accompanying drawings. However, the present disclosure is not limited to the precise arrangements and instrumentalities shown. Similar elements in different implementations are designated using the same reference numerals.

FIG. 1 is a front view of a swing gap cover system in the closed position, according to one implementation.

FIG. 2 is a detailed view of a swing gap cover device of the swing gap cover system of FIG. 1.

FIG. 3 is a perspective view of the swing gap cover system of FIG. 1 in the opened position.

### DETAILED DESCRIPTION

The devices, systems, and methods disclosed herein provide for a device to conceal the swing gap of a door. Specifically, the device is most useful in hidden door applications where a necessary swing gap between the edges of the entryway and the door allows light from the hidden room to pass through the gap, exposing the hidden door as a door. The device can be coupled to the top of the entryway (e.g., to or within the head jamb of the door jamb) and includes a seal bar that is biased by one or more springs toward the top edge of the door. The seal bar covers the swing gap at the top of the door to prevent light from passing through the swing gap.

The seal bar is sized and positioned such that at least a portion of the seal bar is always in contact with at least a portion of the top edge of the door throughout the door's swing. Thus, as the door opens, the seal bar remains at least partially supported by the top edge of the door. As the door is shut, the top edge of the door is wedged beneath the previously unsupported portion of the seal bar, urging the previously unsupported portion of the seal bar upward to allow the door to close under it. Therefore, no trigger or switch mechanism is necessary to cause the seal bar to move when the door is open and/or shut.

The device also includes a torsion device including a bolt or other threaded fastener. The bolt or other threaded fastener is located in a countersunk through opening in the seal bar and the end of the bolt of threaded fastener is threaded into a threaded opening in a base of the device or in the head jamb. The bolt or threaded fastener can be rotated to compress the one or more springs and limit the maximum distance that the seal bar can extend toward the top edge of the door.

Various implementations include a swing gap cover device. The device includes a base, a seal bar, and one or more springs. The seal bar is configured to contact a top edge of a door hingedly coupled to the door jamb. The one or more springs are coupled to the base and the seal bar. The one or more springs are configured to bias the seal bar toward an extended position and urgable toward a retracted position. The seal bar is further from the base in the extended position than it is in the retracted position.

Various other implementations include a swing gap cover system. The system includes a door, a door jamb including a head jamb, and a device coupled to the head jamb. The device includes a seal bar and one or more springs coupled to the seal bar. The one or more springs are configured to bias the seal bar toward an extended position and urgable toward a retracted position. The seal bar is further from the head jamb in the extended position than it is in the retracted position. The seal bar is configured to contact a top edge of the door in the retracted position.

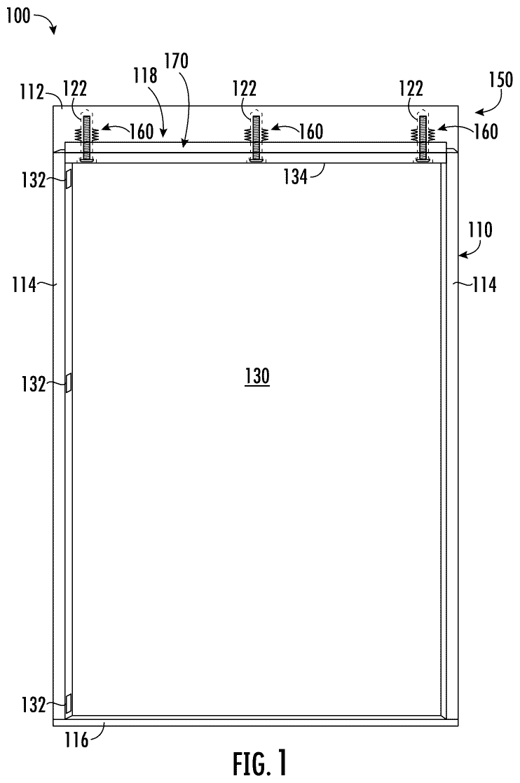

FIGS. 1-3 show a swing gap cover system 100 having various aspects according to one implementation. The system 100 includes a door jamb 110, a door 130, and a swing gap cover device 150. The door jamb 110 includes a head jamb 112, two side jambs 114, and a threshold 116. However, in some implementations, such as those in which the system is part of a hidden door, one or more components of the door jamb may be incorporated into the surrounding structure and may not be traditional components of a standard door jamb. The door 130 includes hinges 132 that hingedly couple the door 130 to one of the side jambs 114 of the door jamb 110. However, in some implementations, the hinges of the door include a hinge pin system hingedly coupling the top and bottom edges of the door to the head jamb and the threshold.

The head jamb 112 shown in FIGS. 1-3 defines an opening or a recessed portion 118. The recessed portion 118 of the head jamb 112 shown in FIGS. 1-3 acts as a base 112 of the swing gap cover device 150 to couple the device 150 to the door jamb 110. However, in some implementations, the device includes a separate base that can be coupled to the head jamb of the door, for example, within an opening or recessed portion of the head jamb. Although the device shown in FIGS. 1-4 is coupled to the head jamb of the door jamb, in some implementations, the device can be coupled to a side jamb, a threshold, a top portion of the door, a bottom portion of the door, a side portion of the door, any other portion of a door system, and/or any combination thereof that allows the seal bar to cover the gap between the door and the entryway, as discussed below.

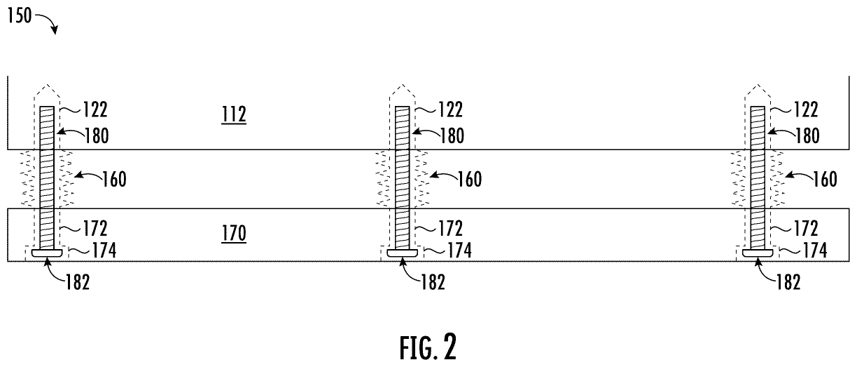

FIG. 2 shows a detailed view of the swing gap cover device 150. The device 150 includes a seal bar 170 and three springs 160. Each of the springs 160 is coupled to a portion of the base 112 (i.e., the head jamb) of the device 150 and the seal bar 170. The springs 160 shown in FIGS. 1-3 are compression springs, but in some implementations, the springs can include any other type of spring or device that provides a resilient spring force when the seal bar is compressed toward the base. Although the device 150 shown in FIGS. 1-3 includes three springs 160, in some implementations, the device can include any number of one or more springs.

The springs 160 are configured to bias the seal bar 170 toward an extended position and are urgable toward a retracted position. In the extended position, the seal bar 170 is further from the base or head jamb 112 than it is in the retracted position. The device 150 is located in a position such that the seal bar 170 is configured to contact a top edge 134 of the door 130 in the extended position. The seal bar 170 shown in FIGS. 1-3 is made of wood to prevent damaging the top edge 134 of the door 130, but in some implementations, the seal bar can be made out of any other material. In some implementations, the seal bar is made out of any wood that has a lower Janka hardness rating than pine. In some implementations, the seal bar is made out of any material that has a lower Mohs hardness rating than pine. In some implementations, the seal bar is made of a metal such as aluminum or steel. In some implementations, the seal bar is made out of any suitable material for contacting the top edge of a door.

The base 112 defines three threaded openings 122 that are each aligned with the central opening of one of the compression springs 160. The seal bar 170 defines three through openings 172 each aligned with the central opening of one of the springs 160. Each of the through openings 172 of the seal bar 170 further defines a countersunk portion 174 on the face of the seal bar 170 opposite the springs 160.

The device 150 includes three tensioning devices 180 to limit the expansion of the springs 160, effectively limiting the maximum distance between the head jamb 112 and the seal bar 170. The tensioning devices 180 shown in FIGS. 1-3 include three bolts, but in some implementations, the tension device can include any mechanism configured to limit the maximum distance between the base/head jamb and the seal bar.

One of the bolts of the tensioning devices 180 is disposed within a different one of the through openings 172 of the seal bar 170 such that the head 182 of the bolt 180 is disposed within the countersunk portion 174 and does not extend beyond the outer surface of the seal bar 170.

The other end of the bolt 180 is threadingly engaged with the threaded opening 122 that is aligned with the same spring 160 as the through opening 172 in which it is disposed. The bolt 180 can be rotated to increase the length of the bolt 180 disposed within the threaded opening 122, decreasing the distance from the bolt head 182 to the base 112. Because the bolt head 182 is disposed within the countersunk portion 174 of the through opening 172 but cannot pass through the through opening 172, the decrease in distance between the bolt head 182 and the base 112 causes the seal bar 170 to move closer to the base 112. The springs 160 create a resilient force on the seal bar 170 to urge it to the maximum distance from the base 112 that the tensioning device bolts 180 allow. This ensures that the springs 160 urge the seal bar 170 onto the top edge 134 of the door 130 when the door 130 is in the closed position but do not allow the seal bar 170 to extend too far when the door 130 is in the opened position.

Although the tensioning devices 180 shown in FIGS. 1-3 include bolts, in some implementations, the tensioning device(s) can include one or more devices designed to adjustably restrict the maximum distance from the base that the seal bar can move. In some implementations, the tensioning device can include any type of fastener, such as a screw or other threaded fastener, a dowel, a clip, or a strap. In some implementations, the device does not include springs and relies on gravitational force to urge the seal bar to the maximum distance from the base.

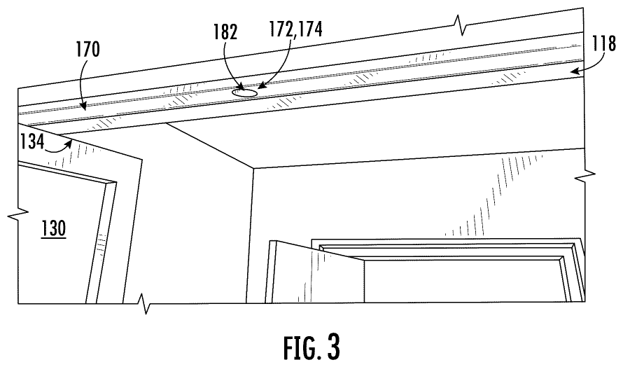

Because the door 130 shown in FIGS. 1-3 is a hidden door, the door hinges 132 are configured such that a portion of the door 130 adjacent to the side jamb 114 to which the door 130 is hingedly coupled is always under the seal bar 170. Thus, a portion of the seal bar 170 always maintains contact with at least a portion of the top edge 134 of the door 130 throughout the door's 130 swing. When the door 130 is in the closed position, as shown in FIG. 1, the full seal bar 170 rests on the top edge 134 of the door 130. As the door 130 opens, more of the top edge 134 of the door 130 swings out from under the seal bar 170, and the springs 160 cause the unsupported portion of the seal bar 170 to extend beyond a plane defined by the top edge 134 of the door 130. However, the tensioning device bolts 180 restrict the maximum distance that the unsupported portion of the seal bar 170 extends beyond the top edge 134 of the door 130 to prevent the unsupported end of seal bar 170 from dropping too far. The door 130 and device 150 are configured such that, when the door 130 has swung to the fully opened position, as shown in FIG. 3, at least a portion of the top edge 134 of the door 130 remains under the seal bar 170.

When the door 130 begins to move from the opened position back toward the closed position, the top edge 134 of the door 130 wedges under the seal bar 170, which has been restricted by the tensioning device bolts 180 from dropping to a severe angle relative to the plane defined by the top edge 134 of the door 130. As the door 130 continues to close, the door 130 continues to force itself under the seal bar 170, lifting the unsupported end of the seal bar 170 as it closes. Once the door 130 has returned to the fully closed position shown in FIG. 1, the seal bar 170 is urged by the springs 160 against the full top edge 134 of the door 130 to cover the entire swing gap between the top edge 134 of the door 130 and the head jamb 112.

A number of example implementations are provided herein. However, it is understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

Disclosed are materials, systems, devices, methods, compositions, and components that can be used for, can be used in conjunction with, can be used in preparation for, or are products of the disclosed methods, systems, and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device are disclosed herein, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

What is claimed is:

1. A swing gap cover device, the device comprising:
a base;
a seal bar configured to contact a top edge of a door hingedly coupled to the door jamb;
one or more springs coupled to the base and the seal bar, wherein the one or more springs are configured to bias the seal bar toward an extended position and urgable toward a retracted position, wherein the seal bar is further from the base in the extended position than it is in the retracted position.

2. The device of claim 1, further comprising one or more tensioning devices configured to limit a maximum distance between the base and the seal bar.

3. The device of claim 2, wherein the one or more tensioning devices comprise one or more threaded fasteners, wherein rotation of the one or more threaded fasteners changes the maximum distance.

4. The device of claim 3, wherein the base defines one or more threaded openings, wherein the seal bar defines one or more through openings, wherein each of the one or more threaded fasteners is disposed within a different one of the one or more through openings and is threadingly engaged with a different one of the one or more threaded openings.

5. The device of claim 4, wherein each of the one or more through openings defines a countersunk portion, wherein the one or more threaded fasteners includes a head disposed within the countersunk portion of the different one of the one or more through openings in which the threaded fastener is disposed.

6. The device of claim 1, wherein the one or more springs comprises two or more springs.

7. The device of claim 1, wherein the one or more springs comprises one or more compression springs.

8. The device of claim 1, wherein the seal bar comprises wood.

9. The device of claim 1, wherein the base is configured to be disposed within an opening in a head jamb of a door jamb.

10. The device of claim 1, wherein the base is a portion of a head jamb of a door jamb.

11. A swing gap cover system, the system comprising:
a door;
a door jamb including a head jamb; and
a swing gap cover device coupled to the head jamb, the device comprising:
a seal bar, and
one or more springs coupled to the seal bar, wherein the one or more springs are configured to bias the seal bar toward an extended position and urgable toward a retracted position, wherein the seal bar is further from the head jamb in the extended position than it is in the retracted position,
wherein the seal bar is configured to contact a top edge of the door in the extended position.

12. The system of claim 11, wherein the device further comprises one or more tensioning devices configured to limit a maximum distance between the head jamb and the seal bar.

13. The system of claim 12, wherein the one or more tensioning devices comprise one or more threaded fasteners, wherein rotation of the one or more threaded fasteners changes the maximum distance.

14. The system of claim 13, wherein the device further comprises a base, wherein the one or more springs are coupled to the base and the seal bar, wherein the seal bar is further from the base in the extended position than it is in the retracted position, wherein the base defines one or more threaded openings, wherein the seal bar defines one or more through openings, wherein each of the one or more threaded fasteners is disposed within a different one of the one or more through openings and is threadingly engaged with a different one of the one or more threaded openings.

15. The system of claim 14, wherein each of the one or more through openings defines a countersunk portion, wherein the one or more threaded fasteners includes a head disposed within the countersunk portion of the different one of the one or more through openings in which the threaded fastener is disposed.

16. The system of claim 11, wherein the one or more springs comprises two or more springs.

17. The system of claim 11, wherein the one or more springs comprises one or more compression springs.

18. The system of claim 11, wherein the seal bar comprises wood.

19. The system of claim 11, wherein the device further comprises a base, wherein the one or more springs are coupled to the base and the seal bar, wherein the seal bar is further from the base in the extended position than it is in the retracted position.

20. The system of claim 19, wherein the base is configured to be disposed within an opening in the head jamb of the door jamb.

21. The system of claim 19, wherein the base is a portion of the head jamb of the door jamb.

22. The system of claim 11, wherein the door comprises a hidden door.

23. The system of claim 11, wherein a portion of the door remains in contact with the seal bar throughout the entire swing of the door.
